(19) United States
(12) Patent Application Publication
(10) Pub. No.: US 2012/0232915 A1
(43) Pub. Date: Sep. 13, 2012

(54) SYSTEM AND METHOD FOR MONITORING A UTILITY METER NETWORK

(76) Inventor: Seth Bromberger, San Francisco, CA (US)

(21) Appl. No.: 13/339,509

(22) Filed: Dec. 29, 2011

Related U.S. Application Data
(60) Provisional application No. 61/451,864, filed on Mar. 11, 2011.

(51) Int. Cl. G06F 15/00; G06Q 50/06

(52) U.S. Cl. 705/1.1; 702/127

(57) ABSTRACT

Embodiments of the invention provide a method for monitoring a utility meter network. The method includes receiving data from a front-end utility application suite that communicates with one or more utility meters and storing the data in one or more databases. The method includes organizing the data according to the utility meter from which the data originated and processing the data using one or more rules to detect patterns and correlations indicative of one or more suspicious events. In some embodiments, the processed data is stored in a database and a report is produced if patterns and correlations indicative of one or more suspicious events are detected.

### RELATED APPLICATIONS

This application claims priority under 35 U.S.C. §119 to U.S. Provisional Patent Application No. 61/451,864 filed on Mar. 11, 2011, the entire contents of which is incorporated herein by reference.

### BACKGROUND

Some conventional utility meters can be used in houses and other structures to measure use gas, electricity, water, and other metered products that are billed on usage. At least some of these meters measure use and display the amount used on a dial or electric display. These passive displays may be visualized by a customer or representative from the utility provider in order to be recorded. Moreover, at least a portion of these conventional meters can be vulnerable to malicious acts by the customer or other individuals or can be susceptible to service problems. However, these problems may go undetected for certain periods of time because at least some of these conventional meters are not actively monitored, and even networked meters are often not monitored in a sophisticated manner. Monitoring of malicious and/or anomalous behavior on networks, such as utility networks, can confer benefits upon the users and operators of the network.

Additionally, detection of suspicious, malicious, and/or anomalous behavior and activities can possibly help reduce costs for users. For example, at least some utility network operators and administrators may need to increase utility rates for all customers in order to account for malicious acts by some customers leading to utility theft. By detecting at least some suspicious, malicious, and/or anomalous behavior, utility network operators and administrators and, as a result, utility customers, can avoid at least some of the costs associated with utility theft.

Furthermore, detecting at least some suspicious, malicious, and/or anomalous behavior can potentially improve utility network safety. Under some circumstances, attempting to steal utilities can involve alteration of utility meters and utility network-associated equipment. As a result, customers and others attempting to steal utilities can compromise the integrity and safety of at least some of this equipment. For example, alteration of some electrical network-associated equipment can potentially expose live electrical wires that may injure the customer, utility network employees, and/or other individuals. Moreover, alteration of some natural gas network-associated equipment can potentially create natural gas leaks, which can lead to significant harm and/or injury to neighboring individuals and property. By being able to detect at least some suspicious, malicious, and/or anomalous behavior, the utility network can attempt to reduce risks associated with unauthorized altering of utility network-associated equipment and utility meters.

### SUMMARY

Some embodiments of the invention provide a security and event monitoring system for a utility meter network. In some embodiments, the monitoring system can provide an infrastructure for readily developing and implementing new monitoring applications. In some embodiments, the monitoring system can analyze and compare information from many sources such as utility meters, one or more customer billing databases, and meter event data and uses protocols to identify anomalies likely related to security violations, power outages, or service issues. In some embodiments, the monitoring system can develop a set of rules where one or more of the rules can be applied to the information and data in order to flag suspicious events indicative of such anomalies or power outages of any duration. Some embodiments of the monitoring system generate reports, including information and/or flagged suspicious events, that are available for user review, analysis, and corrective action.

### DESCRIPTION OF THE DRAWINGS

FIG. 1 is a block diagram of a utility meter network including a monitoring system according to one embodiment of the invention.

FIGS. 2A and 2B are objects stored by the monitoring system of FIG. 1.

FIG. 3 is an architecture diagram of the monitoring system according to one embodiment of the invention.

FIG. 4 is a partial block diagram of a utility meter network including a monitoring system according to another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

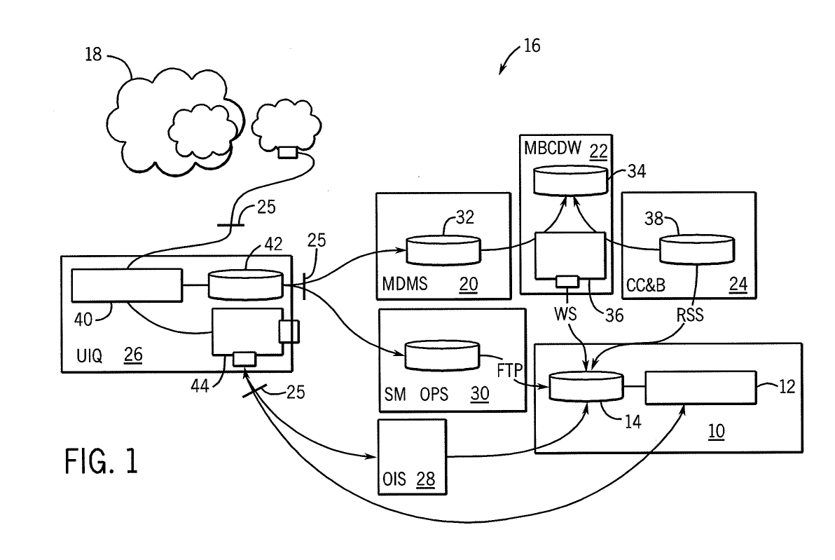

FIG. 1 illustrates a monitoring system 10 according to one embodiment of the invention. The monitoring system 10 can include one or more applications 12 that can be stored in a memory and is executable by a processor using one or more databases 14. The monitoring system 10 can be in communication with a utility meter network 16 and can analyze information specific to utility meters 18 (e.g., end points) of the utility meter network 16. In some embodiments, the monitoring system 10 can analyze the information to determine patterns that can indicate problematic utility meters 18 and possible fraudulent activity at specific utility meters 18 or within specific areas of a utility meter network 16 (e.g., suspicious, anomalous, and/or malicious events). For example, in some embodiments, the monitoring system 10 can retrieve and analyze information for all or some portions of an advanced metering infrastructure network (e.g., a smart grid network).

In some embodiments, the information can include, but is not limited to, meter data (e.g., usage data as conveyed by meters), firewall data, customer data, secondary network data (e.g., SCADA) billing data, corporate security data, smart grid network data regarding multiple meters, and/or individual meter event data. The information can be retrieved from one or more of the following components of the network 16: utility meters or end points 18 directly (e.g., natural gas meters, electric smart meters, water meters, a network or mesh of radio frequency network access points, home area networks communicating wirelessly or using wires, etc.), a meter data management system 20, a measure, bill, and collect data warehouse 22, a customer care and billing database 24, a front-end utility application suite 26, an outage information system 28, a smart meter operations system 30, and any other databases, data sources, and/or data processing infrastructures that can be configured and arranged for use by the monitoring system 10

In some embodiments, the meter data management system 20 can provide data storage and data management of meter data, such as usage data and events, collected by one or more of the utility meters 18 (e.g., via one or more automated meter reading systems). The meter data management system 20 can analyze the meter data received and can perform validation, estimation, and/or editing routines to create integrated, bill-ready data sets of the meter data. The data sets as well as a log of the editing and/or corrections made to the meter data can be stored by the meter data management system 20, for example within a database 32. Other applications of the network 16 can receive the data sets and other data from the meter data management system 20 for analysis, billing purposes, customer service, audits, etc.

In some embodiments, the measure, bill, and collect data warehouse 22 can act as a long-term data repository for the meter data analyzed and stored by the meter data management system 20. For example, the meter data management system 20 can stream the data collected and the data sets created at specific intervals to the measure, bill, and collect data warehouse 22 (e.g., to a database 34 of the measure, bill, and collect data warehouse 22). In some embodiments, the meter data can be stored for a first time period by the meter data management system 20 (e.g., about 14 months), and can be stored for a second, longer time period by the measure, bill, and collect data warehouse 22 (e.g., about 7 years). In some embodiments, one or both of the meter data management system 10 and the measure, bill, and collect data warehouse 22 can store the meter data for a period of time greater than 7 years (e.g., indefinitely). The measure, bill, and collect data warehouse 22 can be accessible by application interfaces of the network 16 for retrieval of the stored meter data (e.g., through a web service interface 36).

In some embodiments, the customer care and billing database 24 can store customer information and billing information (e.g., within a database 38, as shown in FIG. 1). For example, the customer care and billing database 24 can store customer identification, corresponding smart meter location, customer credit information, account balances, account delinquency information, etc.

In some embodiments, the outage information system 28 can collect and analyze outage event data and meter restoration data. For example, the outage information system 28 can store outage data logs for outage/restoration accounting and reporting, and track and resolve outage events by time, type, and/or duration. The outage information system 28 can receive “last gasp” information from utility meters 18 as well as real time restoration notices.

In some embodiments, the monitoring system 10 can be in communication with a substation automation system (not shown) and a power distribution system (not shown) comprising power feeders. For example, in some embodiments, the power feeders can include one or more groups of meters 18 connected to one or more nodes (not shown). The monitoring system 10 can collect and analyze outage event data and meter restoration data originating from the power feeders. In some embodiments, the monitoring system 10 can process the event and meter restoration data to assess whether the groups of meters 18 experience short-lived or long-lived power outages. For example, a short-lived power outage can comprise some or all of the power outages lasting less than about five minutes and a long-lived power outage can comprise some or all of the power outages lasting longer than about five minutes. In some embodiments, the processing of some or all of this power outage data can assist an outage management team in managing performance of power feeders and other protective devices in the power distribution system.

In some embodiments, the front-end utility application suite 26 can include administrative tools, programs, applications 40, etc. to configure, manage, and update the network 16. In addition, in some embodiments, the front-end utility application suite 26 can substantially continuously communicate with the utility meters 18 in real time. In other embodiments, the front-end utility application suite 26 can communicate with the utility meters 18 on a periodic or as-needed basis. In some embodiments, the front-end utility application suite 26 can also include a database 42 and one or more web service interfaces 44.

The front-end utility application suite 26 can function as an intermediary between back-end components of the network 16 and the utility meters 18. As a result, the back-end components can acquire consistent meter data independent of the automated meter reading systems used at the utility meters 18. For example, the front-end utility application suite 26 can acquire the meter data from the utility meters 18. The meter data can then be transferred to the meter data management system 20 (e.g., the database 34 of the meter data management system 20) for storage and analysis. In another example, the front-end utility application suite 26 can acquire outage event data from one or more of the utility meters 18, which can then be transferred to the outage information system 28.

In one embodiment, the front-end utility application suite 26 can include data analysis routines (e.g., executed by a processor, not shown) to analyze the collected meter data prior to transferring the meter data to the meter data management system 20. In addition, the front-end utility application suite 26 can provide communication between the back-end components and customers. For example, meter data reports, meter outage reports, and other types of reports can be produced by the back-end components and output to the front-end utility application suite 26. Through the web service interfaces 44, customers can request and receive such reports. In some embodiments, at least some portions of the monitoring system 10 can communicate with other information sources (e.g., databases) that include data regarding potential security risks, public records, and any other data that would be desirable when monitoring the network 16.

In some embodiments, the monitoring system 10 can comprise one or more protective layers 25 (e.g., firewalls) between different components, as shown in FIG. 1. For example, the interface between the meters 18 and the front-end utility application suite 26 can comprise a firewall 25. In some embodiments, in addition to, or in lieu of, the firewall 25 between the meters 18 and the front-end utility application suite 26, the interface between the front-end utility application suite 26 and other portions of the monitoring system 10 can comprise one or more firewalls 25. As a result of the multiple layers of firewalls 25, communications between different elements of the monitoring system 10 can be securely transmitted. Moreover, in some embodiments, by including multiple firewalls 25 in the system 10, system administrators can increase their chances of detecting any attempted tampering with components of the monitoring system 10 by detecting tampering at the firewalls 25.

In some embodiments, the smart meter operations system 30 can function as a meter reporting center that can act as an intermediary between the front-end utility application suite 26 and the some or all of the back-end components of the network 16. In addition, in some embodiments, one or more of the actions described above in relation to each of the network 16 components may be executed by a different component or multiple components.

The data collected and analyzed by the components of the network 16 can be retrieved by the monitoring system 10 over public or private wireless and/or wired communications. For example, the monitoring system 10 can retrieve some of the information from the customer care and billing database 24 as encrypted files (e.g., RSS files) using a secured HTTP GET method (e.g., by a PULL operation by the monitoring system 10) at predetermined time intervals (e.g., an hourly interval, a daily interval, a weekly interval, a monthly interval, or any other regular or irregular intervals). In another example, the monitoring system 10 can retrieve some of the information from the meter data management system 20 by file transfer protocol (FTP) and/or a secure file transfer protocol (SFTP) data PUT operations. In yet another example, the monitoring system 10 can retrieve some of the information from the front-end utility application suite 26 through web service Simple Object Access Protocol (SOAP) communications. Some of the information can be retrieved by the monitoring system 10 in near-real time (e.g., via SOAP communications) and some of the information can be retrieved at set time intervals (e.g., via FTP PUT and HTTP GET operations). In addition, different kinds of information can be retrieved at different time intervals, as described. For example, the monitoring system 10 can update base meter data once per day, can update meter events about every four hours, and can update meter states about every two hours. In some embodiments, at least a portion of the data transferred across the network 16 can be encrypted.

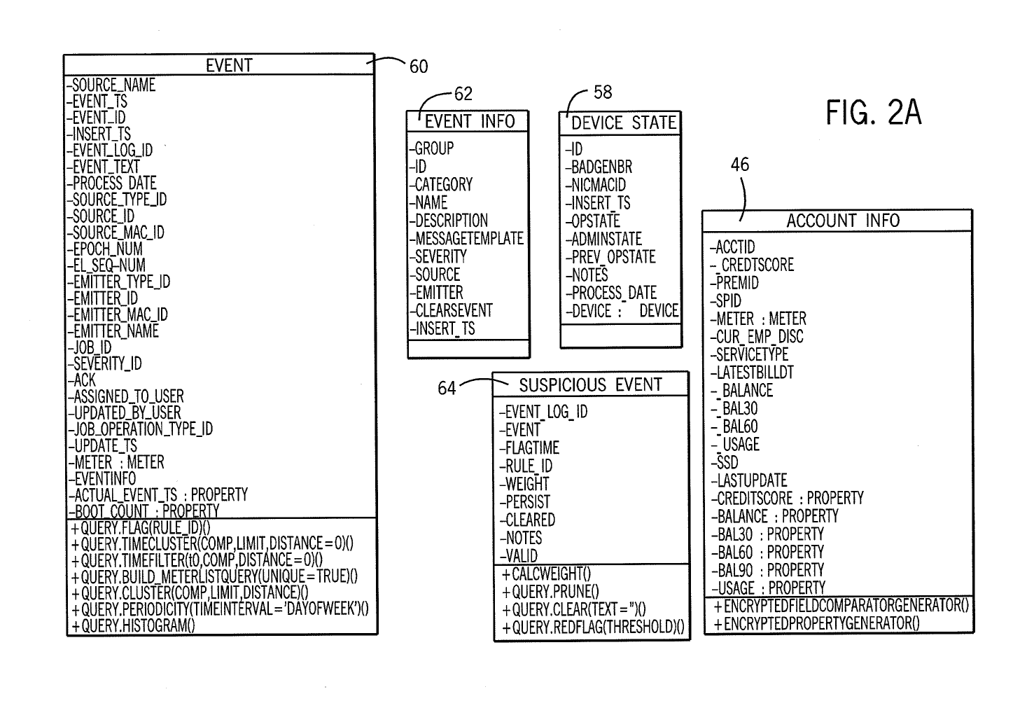

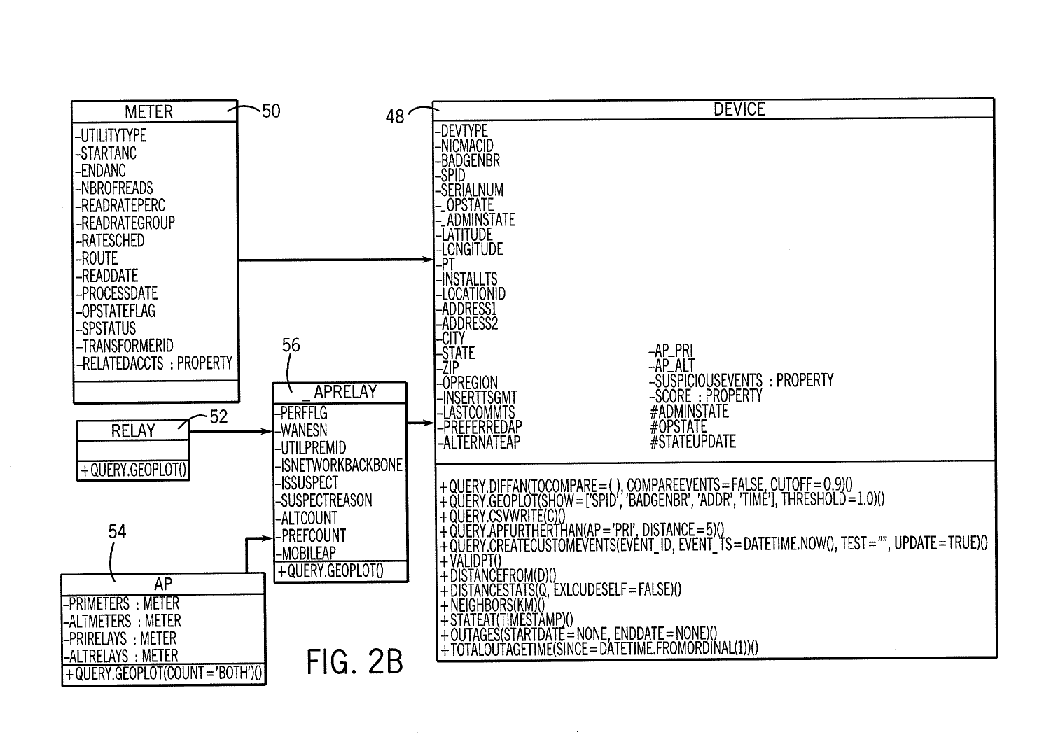

All of the information retrieved by the monitoring system 10 can be stored in the monitoring system database 14 in relation to a corresponding utility meter 18. For example, as shown in FIGS. 2A and 2B, the information can be stored as multiple objects in relation to a specific utility meter. Such information can be retrieved from one or more of the utility meters 18 directly, the front-end utility application suite 26, the outage information system 28, the customer care and billing database 24, and/or the meter data management system 20. In some embodiments, some of the information retrieved can be converted to a desired format prior to being stored in the monitoring system database 14. In addition, some of the information may be static information (e.g., meter location information), while some of the information may be dynamic information (e.g., updates and meter events information).

In some embodiments, some of the information can relate to account information for a specific utility meter 18. The account information can be generated in extensible markup language (XML) format as an “AccountInfo” object 46, as shown in FIG. 2A. The monitoring system 10 can retrieve the account information from the customer care and billing database 24 such as customer identification, smart meter location, customer credit information, account balances, account delinquency information (e.g., days past due and amount past due), etc. Moreover, in some embodiments, the account information object 46 can include account identification, customer internal credit score, associated meter identification, service type, latest bill to date, balance on latest bill, balance 30 days prior to latest bill, balance 60 days prior to latest bill, other balance data, meter usage, or any other information relevant to a user's account.

In some embodiments, some of the information can relate to properties of the specific utility meter. The meter property information can be generated in XML format as an “Device” object 48, as shown in FIG. 2B. For example, the meter property information can include the type of meter, a network interface card (NIC) media access control (MAC) address, a serial number, whether the meter is in operation state or administrative state, the latitude and longitude of the utility meter location, the street address of the utility meter location, access points used, etc.

In some embodiments, some of the information can be stored as objects in relation to the Device object 48, as shown in FIG. 2B. For example, a “Meter” object 50 can include meter properties, a “Relay” object 52 (e.g., a Network Repeater and/or relay) can include properties related to any relays, such as network relays, used for communication between the utility meter 18 and the front-end utility application suite 26, an “AP” object 54 can include properties related to any access points, such as network access points, used for communication between the utility meter 18 and the front-end utility application suite 26, and an “APRelay” object 56 can include properties related to the access point and relay pathway between the utility meter 18 and the front-end utility application suite 26. Also, in some embodiments, a separate object, such as the “DeviceState” object 58, as shown in FIG. 2A, can store information related to the state of the utility meter, including meter identification, NIC MAC address, operational state, administrative state, notes, etc.

In some embodiments, some of the information can relate to events observed by the utility meter 18. The event information can be generated in XML format as an “Event” object 60, as shown in FIG. 2A. For example, the event information can include event type, event identification, an identifier of the event as it is stored in an event log database, meter identifier for meter 18 signaling the event, process date, source type, source identification, emitter type, emitter identification, job identification, severity of event, etc. In addition, an “EventInfo” object 62 can include general event information such as a group, identification, category, name, description, message template, severity, allowed source, and/or emitter of specific events.

In some embodiments, some of the information can relate to events labeled as “suspicious events”. The suspicious event information can be generated in XML format as a “SuspiciousEvent” object 64, as shown in FIG. 2A. For example, the suspicious event information can include an identifier of the suspicious event as it is stored in an event log, the event itself, the time it was flagged as a suspicious event, notes, etc. Suspicious events can be a single meter event, multiple meter events, and/or other meter information which, according to rule sets of the monitoring system 10, correlate with suspect patterns indicative of fraudulent use of one or more utility meters 18 and/or maintenance issues with one or more utility meters 18, as described in further detail below.

Moreover, in some embodiments, at least some of the functions of the monitoring system 10 can be associated with representations of the objects stored by and/or processed by some elements of the system 10. For instance, in some embodiments, the objects can be organized and represented at least partially based on data source, such as the utility network 16 (e.g., meters 18, access points, different management systems and their associated data, including events, alters, and metrology), customers (e.g., demographics, premise, financial information, billing data, etc.), and/or other internal structures (e.g., revenue assurance models, workflow schedules, etc.). In some embodiments, some or all of these objects can be organized in different manners to achieve user needs and requirements.

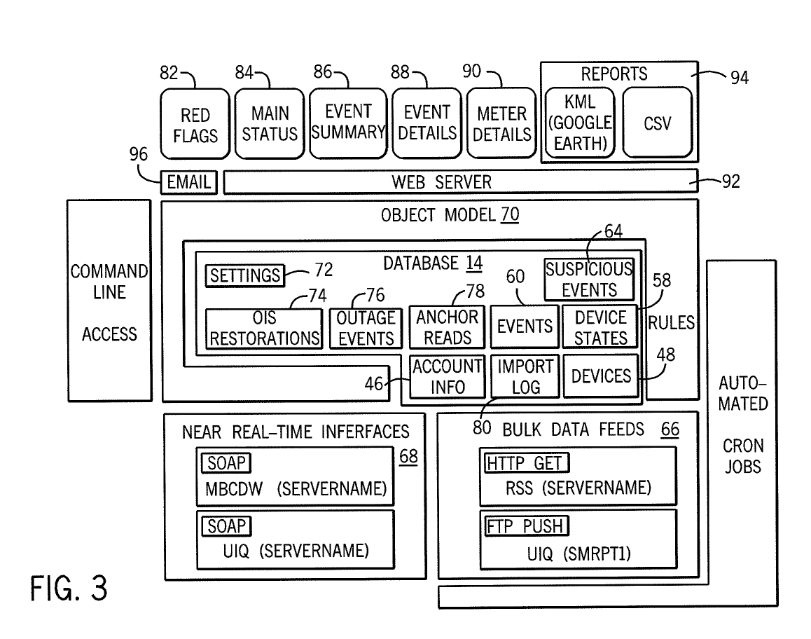

FIG. 3 illustrates an architecture of the monitoring system 10 according to one embodiment of the invention. As shown in FIG. 3, objects can be stored in the monitoring system database 14. In addition to the objects described above, other objects such as settings 72, OIS restorations 74, outage events 76, anchor reads 78, and an import log object 80 can be stored in the monitoring system database 14. The information stored in relation to the objects can be received through bulk data feeds 66 (e.g., HTTP GET and FTP Push) or near real-time interfaces 68 (e.g., SOAP), as described above. In some embodiments, information transfer can be executed automatically, for example at specific time intervals. In some embodiments, some or all of the previously mentioned objects can be stored within the database 14 or other databases and can be at least partially organized with several indices to optimize searching for the objects.

FIG. 3 also illustrates an object model 70 of the monitoring system 10, including rules executed with the information stored in relation to one or more of the above-described objects. The rules can be executed in order to determine suspect patterns and flag and store suspicious events. Meter information, such as red flags (i.e., of suspicious, anomalous, and/or malicious events) 82, main statuses 84, event summaries 86, event details 88, meter details 90, etc. can be communicated from the monitor system 10 through a web server 92. In addition, some information can be communicated through email 96.

For example, once suspicious events are determined by the monitoring system 10 or on specific time intervals, reports 94 of meter information can be generated in KML (keyhole markup language) format or CSV (comma separated values) format. The reports 94 can be used by an administrator or data analysis specialists of the monitoring system 10 to determine where physical inspection, or further investigation, of utility meters 18 may be necessary. For example, through a report 94 generated in KML format, utility meters 18 flagged with suspicious events can be plotted on electronic maps, for example, Google Earth®. Groups or clusters of utility meters 18 flagged with suspicious events shown in Google Earth® can indicate fraudulent activity in that area, enabling scheduling of prompt physical examination of the utility meters 18 in that area. For example, some system 10 administrators and utility employees can view at least some of the electronic maps on mobile devices such as, but not limited to, mobile telephones, smart phones, portable computers, tablet computers, personal digital assistants, laptops, and any other device configured and arranged for portability when physically inspecting utility meters 18. In another example, reports 94 can be generated in a prioritized manner, such as by days left in billing cycle so that problematic meters 18 can be attended to and fixed prior to the next billing cycle.

In some embodiments, the reports can be generated on a regularly scheduled basis. In some embodiments, an administrator of the monitoring system 10 can request specific or custom reports 94 to be generated. For example, the administrator can request a report 94 specific to a single utility meter 18 or to a group of available utility meters 18 in a specific area. In another example, the administrator can request a report 94 specific to one or more business customers. The monitoring system 10 can filter the information using the parameters requested by the administrator and generate a specific report 94, for example in near-real time rather than on a next scheduled report generation date (e.g., the monitoring system 10 can generate one or more “on-demand” reports 94). The reports 94 can also be used by revenue assurance groups, smart meter operations groups, smart meter information security groups, smart meter distribution outage analysis groups, energy demand marketing groups, etc. In addition, reports 94 can be communicated to customers through end-user interfaces via the web server 92. In some embodiments, in the case of suspicious events that may be illegal activity, the reports 94 can be communicated to local authorities (e.g., police enforcement, prosecutor's office, etc.) for potential prosecution of crimes. In some embodiments, reports 94 can be generated automatically by one or more applications, as discussed below. Moreover, in other embodiments, reports 94 can be generated automatically and/or manually by a system 10 user.

In some embodiments, the monitoring system 10 can be configured and arranged to provide resources for discovering potentially malicious exploitation of the network 16. For example, the network 16 and/or the monitoring system 10 can comprise one or more deceivingly vulnerable resources that may appear attractive for potential attacks and/or depositing malicious software (e.g., the system 10 can comprise a “honeypot” resource). An individual or system attempting to gain access to the system 10 or network 16 via the deceivingly vulnerable resource can be readily discoverable by system administrators. As a result, system administrators can attempt to stop the individual or system and/or collect information related to the attempted intrusion to develop additional analytical capabilities.

For example, in some embodiments, the deceivingly vulnerable resources can appear as a portion of the network 16 (e.g., a network node) to some outside individuals or systems. The vulnerable resources can include a network interface that can function as an interface between the resources and the network 16 (e.g., the interface can enable peer-to-peer communications and other communications with other network 16 resources). In some embodiments, the network 16 and/or monitoring system 10 can comprise an analysis engine that can receive data (e.g., encrypted data) from the resources via the network interface. The analysis engine can decode any encrypted data and analyze the data to assess whether any attempted access to the vulnerable resources is authorized and can also transmit reports or other data (e.g., packet data, decoding information, timestamps, metadata, etc.) to a backhaul network interface.

In some embodiments, the backhaul network interface can be configured and arranged to securely transmit notice of any unauthorized access attempts to a business processing and alerting system. For example, the backhaul network interface can receive secure data from the analysis engine and can reformat the received data for secure delivery across a backhaul network (e.g., an out-of-band network) to the business processing and alerting system. In some embodiments, the backhaul network can comprise a wired and/or wireless configuration.

The business processing and alerting system can be configured to process the data from the analysis engine and alert, dispatch, respond, and control any other functions of the vulnerable resources. Moreover, in some embodiments, the business processing and alerting system can be configured to remotely manage, upgrade, and/or control the vulnerable resources, provide timely dispatch of alerts transmitted by the analysis engine, and integrate into any other network 16 and/or monitoring system 10 processes already in place.

As described above, one or more rules can be applied by the monitoring system 10 using information from the monitoring system database 14 in order to assess, analyze, spot, and/or flag suspicious events. Generally, the following steps describe an example cycle of the monitoring system 10: meter events and data are collected (e.g., periodically and/or continuously); the meter events and data are analyzed according to rules to determine patterns and correlations indicative of suspicious events; the results of the analysis as well as the meter events and data are stored; and the stored results and/or events and data are published (e.g., through reports 94 and/or website interface queries). In some embodiments, the monitoring system 10 can execute one or more of these steps at the same time.

In some embodiments, rules can be applied at regular or irregular time intervals (e.g., about every twenty minutes). Also, in some embodiments, suspicious events that may already be flagged for a specific meter 18 may or may not be re-flagged, depending on the type of suspicious event. In addition, in some embodiments, additional rules can be developed and added to the monitoring system 10 in response to flagged suspicious events or additional information retrieved from reports 94 generated by the monitoring system 10 (e.g., providing a dynamic production environment). Additionally, in some embodiments, one or more of the databases can comprise a great enough size to accommodate out-of-order events so that the monitoring system 10 can process potentially correlative activity when new data (e.g., data received that is potentially out-of-order relative to previously stored data) is received. As a result, the monitoring system 10 can continue to process in-order and out-of-order data and objects to detect any potentially previously uncorrelated anomalous and/or suspicious conditions.

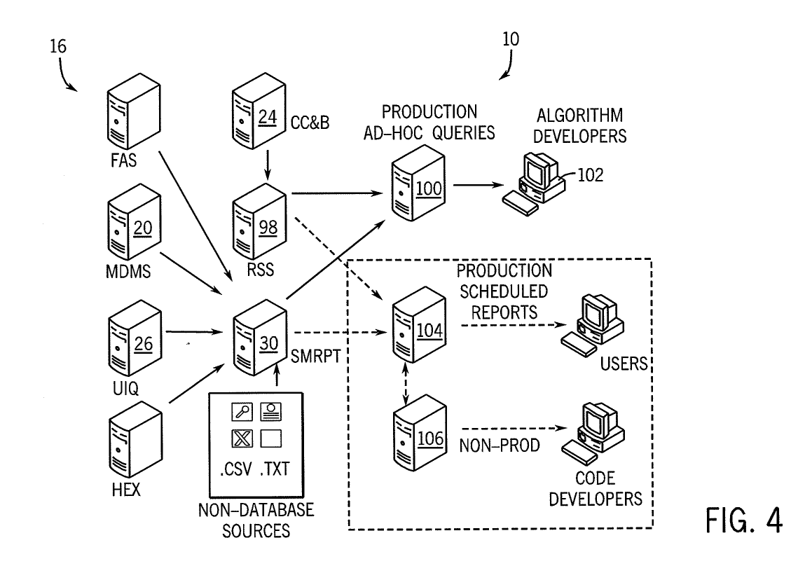

For example, FIG. 4 illustrates a partial block diagram of the network 16 according to another embodiment of the invention. As shown in FIG. 4, data feeds 98 (e.g., RSS feeds) as well as data and/or objects collected by a smart meter reporting system (e.g., the smart meter operations system 30 of FIG. 1) can be queried in an ad-hoc fashion by a production server 100 of the monitoring system 10. System developers 102 and/or administrators of the monitoring system 10 can analyze the queried data in order to refine and develop new rules for the monitoring system 10, as well as discover types of suspicious events that have not been flagged. In addition, as shown in FIG. 4, data feeds 98 as well as data collected by the smart meter report system 30 can be provided to other servers 104, 106 of the monitoring system 10 for report generation for users, consumers, administrators, and/or code developers of the monitoring system 10.

In some embodiments, at least a portion of the following rules can be apportioned into categories. For example, in some embodiments, the monitoring system 10 can apply one or more rules to analyze some or all of the objects using a geospatial analysis, including a k-dimensional tree analysis to assess event anomalies, network 16 misconfigurations based on geographic disparity calculations, and movement of some or all of the objects (e.g., via a time-based geographic analysis). In some embodiments, the monitoring system 10 can also apply an event-based analysis of objects that can include correlation of event data among and between similar and disparate object types, a historical analysis of data based on a given set of objects, and an analysis of events based on volume and/or frequency of a given set of events. In some embodiments, the monitoring system 10 can also apply a time-based analysis of objects including a change in event volume over a predetermined time period both independently and relative to another object or set of objects.

The following paragraphs describe example rules that can be used by the monitoring system 10 in some embodiments. Furthermore, in some embodiments, these rules can be applied on a predetermined basis (e.g., daily, hourly, monthly, etc.) after the monitoring system 10 analyzes a set of potential issues and removes potential issues that may have been noted one or more times (e.g., the monitoring system 10 can be configured to remove duplicate issues prior to further analysis). Moreover, as previously mentioned, in some embodiments, the monitoring system 10 can analyze new data and objects as they are received and the monitoring system 10 can also analyze previously received data in the context of more-recently received data to ensure detection of anomalous and/or suspicious correlations.

In some embodiments, the monitoring system 10 can include rules to assess whether a disconnected meter 18 has been reconnected without monitoring system 10 knowledge or authorization (i.e., an “Unauthorized Reconnection” rule). The monitoring system 10 can employ rules to assess whether a meter 18, which has already been disconnected by the system 10 or otherwise disconnected by the utility provider, has been reconnected to the network 16. For example, the meter 18 or other portions of the network 16 can comprise a remote disconnect switch (e.g., a device that the network 16 or monitoring system 10 can use to remotely deactivate a meter 18) that can detect whether the meter 18 has been connected to an alternate energy source (e.g., the switch can detect load-side voltage that is out of phase) or the remote disconnect switch can detect a bypass condition (e.g., the switch can detect a load-side voltage in phase). As a result of the remote disconnect switch detecting these event, the monitoring system 10 can indicate potential tampering to system administrators so that the meter 18 can be investigated.

In some embodiments, the monitoring system 10 can employ the Unauthorized Reconnection rule in the following steps. For example, if a portion of the monitoring system 10 (e.g., the remote disconnect switch) detects a load-side voltage (e.g., the meter 18 is active) to a meter 18 that has been previously disconnected, the monitoring system 10 can: query the customer care and data billing data warehouse 22 to assess and/or verify the remote disconnect date (e.g., to assure that the date has passed and the utility meter 18 should be inactive); query the front-end utility application suite 26 to assess and/or verify if the disconnection worked and if the meter 18 is actually deactivated; assess event summaries 86, event details 88, and any other information and/or object stored in relation to the meter 18 (e.g., notes and field activities) to determine whether a payment was received and service was reconnected; and query one or more of the databases 14, 32, 34, and 38 to determine whether a new customer-of-record has reactivated the meter 18. If there is no explanation for the load-side voltage, the monitoring system 18 can indicate tampering may have occurred so that a physical inspection can be ordered.

In some embodiments, the monitoring system 10 can include an “Uncommunicative Remote Disconnect Switch” rule. For example, some suspicious events may arise as a result of a person destroying, disconnecting, or otherwise disabling the remote disconnect switch, although, at times, the remote disconnect switch may be disabled due to no malfeasance on the party of any person (e.g., the remote disconnect switch was unintentionally damaged). As a result, the remote disconnect switch may become uncommunicative and unreachable by the monitoring system 10. In some embodiments, when the monitoring system 10 is unable to communicate with the remote disconnect switch and the meter 18 is supposed to be in an inactive state, the monitoring system 10 can: query the customer care and data billing data warehouse 22 to assess and/or verify the remote disconnect date (e.g., to assure that the date has passed and the utility 18 should be inactive); assess event summaries 86, event details 88, and any other information stored in relation to the meter 18 (e.g., notes and field activities) to determine whether the meter 18 was changed or whether the meter or other portion of the end point 18 was damaged at a utility hub (e.g., a utility pole); and assess whether the meter 18 is being physically monitored by a utility employee by checking the configuration of the meter 18 as stored in one or more of the databases 14, 32, 34, and 38. If there is no explanation for the uncommunicative remote disconnect switch, the monitoring system 18 can indicate tampering may have occurred so that a physical inspection can be ordered.

In some embodiments, the monitoring system 10 can include an “Inverted Meter” rule. The monitoring system 10 can employ the Inverted Meter rule to assess the existence of a potential malfunction or whether one or more meters 18 are being operated in unauthorized manners leading to utility theft. In some embodiments, the monitoring system 10 can apply the inverted meter rule to assess situations in which the monitoring system 10 determines that structures connected to one or more meters 18 are generating energy in excess of usage so that energy is being returned to the network 16. Under some circumstances, a structure comprising a photovoltaic system (e.g., a solar system) can produce more energy than it draws from the energy grid, and under some circumstances, portions of a meter 18 can be inverted so that, to the front-end utility application suite 26, it appears that the customer is sending energy back to the energy grid.

In some embodiments, the monitoring system 10 can employ the Inverted Meter rule to assess whether a meter 18 registering excess energy flowing back to the energy is a result of suspicious behavior or arises for other reasons (e.g., extra energy flowing back to the grid originating from a solar system). For example, when employing the Inverted Meter rule, the monitoring system 10 can initially query the front-end utility application suite 26 to determine whether the meter 18 registering excess amounts of energy has been previously associated with any suspicious acts (e.g., prior acts of fraud or other malfeasance, such as an unreachable meter 18 or uncommunicative remote disconnect switch). Moreover, the monitoring system 10 can also assess whether the energy flowing back to the grid is substantially constant or periodic. For example, if the meter 18 is connected to a solar system, any excess energy should be generally generated when the system is exposed to sunlight. Accordingly, if the monitoring system 10 is detecting excess energy flowing back to the grid at night, the account could be flagged for physical inspection.

In some embodiments, the Inverted Meter rule can be implemented in other ways, in addition to or in lieu of some of the previously mentioned implementations. In some embodiments, the monitoring system 10 can employ the Inverted Meter rule to assess the duration of the excess energy registered by the meter 18. For example, if the monitoring system 10 determines that the meter 18 has registered excess energy for a period of time greater than a predetermined threshold (e.g., 48 hours), then the monitoring system 10 can signal to administrators that there may be a malfunction with the meter 18 or potential tampering. Additionally, in some embodiments, the Inverted Meter rule can be implemented by the monitoring system 10 to detect use of inverted meters 18 (i.e., an unauthorized use of meters 18) when excess energy that flows back to the grid is interrupted by a power outage followed by a restoration to the meter 18. Accordingly, if the monitoring system 10 is detects this occurring, the account could be flagged for physical inspection.

The monitoring system 10 can include a “NIC Node Insufficient Privileges” rule. This rule can be implemented to detect a request by a NIC to the meter board, where the NIC has not provided sufficient credentials for authorization, indicating a suspicious event. For example, when a NIC attempts to communicate with a meter board, the NIC passes a shared or common password across a serial link connecting the NIC with the meter board. This password can be intended to authenticate and authorize the NIC to the meter board and to allow the retrieval of register and other data from the meter by the NIC. The suspicious event can be generated, or flagged, if the password does not provide the level of authorization required for the operation requested by the NIC. An unknown or unauthorized request to read or change data or code on the meter board may be indicative of a security attack against the utility meter 18. Failed authorization can be an indicator of an attempt to subvert the security controls in place between the meter 18 and the NIC, which would result in the potential for violations of confidentiality, integrity, or availability of meter data.

The monitoring system 10 can include a “NIC Authentication Failures” rule. This rule can be implemented to detect a number of consecutive authentication failures from the NIC to the utility meter 10, indicating a suspicious event. For example, an unknown or unauthorized request to read or change data or code on the meter board can be indicative of a security attack against the meter. Failed authentication might be an indicator of an attempt to subvert the security controls in place between the meter and the NIC, which would result in the potential for violations of confidentiality, integrity, or availability of meter data.

In addition, the monitoring system 10 can include a rule to determine if a NIC is unable to communicate with a utility meter and/or a rule to determine if a NIC can not access its memory. One or both of these events occurring can indicate a problem with the NIC and/or the meter, which may require further inspection of the utility meter 18.

The monitoring system 10 can include an “Unknown Device” rule. This rule can be implemented to detect unknown devices attempting to communicate with the front-end utility application suite 26, indicating a suspicious event. For example, this event can be generated whenever a device unknown to the front-end utility application suite 26 is trying to communicate, such as a device with an unknown MAC address or results and information referring to an unknown access point. An unknown or unregistered device on the utility network 16 can be the result of malicious activity.

The monitoring system 10 can include an “Anomalous Behavior Detection” rule. This rule can be implemented to detect events that have been sent fewer than a threshold number of times across the entire population of events and devices on the network 16, indicating a suspicious event. For example, the monitoring system 10 can analyze the frequency of events received by utility meters 18, relays, and access points. When an event is sent by a device that has not been sent by a significant number of other devices performing the same function, the event can be flagged as a suspicious event. Generic anomalous detection can help detect attempts to compromise utility meters 18, the RF mesh and communications of the network 16, and/or back-end components of the network 16.

The monitoring system 10 can include an “Unauthorized Shutoff” rule. This rule can be implemented to detect when a meter has processed a service disconnect (e.g., power shutoff) that does not correspond with an activity known by back-end components of the network 16, indicating a suspicious event. For example, utility meters 18 within the network 16 can each include two associated states: administrative and operational. The administrative state can reflect what the other components of the system, such as the front-end utility application suite 26 or the customer care and billing database, have stored regarding the status of the utility meter 18. The operational state can be the state that is reported by the utility meter 18 itself. If the utility meter 18 reports a “disconnect” or “service disconnect” state, but the back-end components indicate that the account is current and the utility meter 18 should be in an “active state”, there exists a possibility of an unauthorized shutoff.

In addition, the monitoring system 10 can include one or more rules to detect general remote disconnect errors, remote disconnect communication errors, remote disconnect failing to open, remote disconnect failing to close, remote disconnect detecting alternate energy sources, remote disconnect detecting meter bypassing, service disconnect device tampering, remote disconnect switch errors, operational state unreachable, bad shut-offs, last gasps, etc.

The monitoring system 10 can include a “Meter Program Changed” rule. This rule can be implemented to detect a change to a meter program (e.g., the logic used in processing electric usage and meter events), indicating a suspicious event. For example, this event can be generated when the meter program, which records meter events, usage, and other data, changes. An unknown or unauthorized change to the meter program can be the result of tampering. The tampering, if detected in a specific timeframe among a specific set of devices, may be an indicator of a mass tampering incident. In addition, the monitoring system 10 can include a rule to detect meter data inversion, as previously mentioned.

In some embodiments, the monitoring system 10 can include other rules that can be helpful in altering system administrators to suspicious activity. For example, when a customer receives multiple utilities from one service provider (e.g., the user receives both natural gas and electricity from one provider), and the monitoring system 10 detects that the customer's meters 18 measure usage indicating that the customer is using one utility (e.g., gas) and not the other utility (e.g., electricity), the monitoring system 10 can indicate to system administrators that possible tampering has occurred. As another example, the monitoring system 10 can comprise a rule that can lead to altering system administrators when too many meters 18 are connected to a single access point that the meters 18 are not responding to queries from the monitoring system 10, the front-end utility application suite 26, or any other elements of the network 16.

As described above, some of the rules can flag a suspicious event when a specific meter event happens, or when a specific meter event happens multiple, consecutive times. In some embodiments, other rules can flag suspicious events when specific meter events happen within the same time frame. In some embodiments, a suspicious event can be flagged only if a number of rules are satisfied (e.g., one rule satisfied on its own does not indicate a suspicious event, but one rule satisfied in addition to a related satisfied rule can indicate a suspicious event). In addition, rules can weigh certain meter events depending on their occurrence within a specific time interval, or their distance in relation to other utility meters reporting the same meter events. Depending on the calculated weights of specific meter events occurring relative to each other, a suspicious event can be flagged. Rules can also factor in weights for days away from billing cycles, balances overdue, credit scores, etc. when determining certain suspicious events. As a result, some rules can detect suspicious events when, for example, a cumulative score of weighted meter events and other data exceeds a threshold. In addition, some of the above-described rules may only add weight to a cumulative score, rather than each causing a suspicious event to be flagged on their own.

Further, some meter events can be disregarded when determining a suspicious event. For example, if the outage information system detects a large outage in an area (e.g., due to weather or a power failure), the outage events for each specific utility meter can be disregarded when determining a suspicious event, such as possible fraudulent shut-down. In another example, some meter events can cause a suspicious event to be de-flagged.

The above-described databases throughout the network 16 and/or the monitoring system 10 can store rules and other data on computer-readable storage media. In addition, the above-described applications of the network 16 and/or the monitoring system 10 can be stored on computer-readable storage media. With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method for monitoring a utility meter network, the method comprising:
receiving data from a front-end utility application suite, the front-end utility application suite being in communication with one or more utility meters;
storing the data in at least one database;
organizing the data in the at least one database according to the utility meter from which the data originated;
processing the data using one or more rules to detect patterns and correlations indicative of one or more suspicious events;
storing the processed data in at least one database; and
producing a report if patterns and correlations indicative of one or more suspicious events are detected.

2. The method of claim 1, wherein the one or more rules comprises an Inverted Meter rule.

3. The method of claim 1, wherein the one or more rules comprises an Unauthorized Reconnection rule.

4. The method of claim 1, wherein the one or more rules comprises a Network Interface Card Node Insufficient Privileges rule.

5. The method of claim 1, wherein the report comprises data that is plotted on an electronic map.

6. The method of claim 1, wherein the data is processed using one or more rules at predetermine time intervals.

7. The method of claim 6, wherein the predetermined time interval comprises about twenty minutes.

8. The method of claim 1, and further comprising developing additional rules at least partially based upon patterns and correlations detected during the data processing.

9. A system for monitoring a utility network comprising:
a utility network in communication with one or more utility meters and a front-end utility application suite, the utility network further comprising one or more of a meter data management system; a measure, bill, and collect data warehouse, an outage information system, and a smart meter operations system;
one or more databases being in communication with the utility network, the one or more databases being configured and arranged to receive and store data from the utility network; and
one or more processors being in communication with the one or more databases, the one or more processors being configured and arranged to process the stored data using one or more rules to detect patterns and correlations indicative of one or more suspicious events, and wherein the one or more processors are further configured to produce a report if patterns and correlations indicative of one or more suspicious events are detected.

10. The system of claim 9, wherein the one or more processors are configured to develop additional rules at least partially based upon patterns and correlations detected during the data processing.

11. The system of claim 9, wherein the one or more processors are configured to receive ad hoc queries from at least one of a system administrator and one or more servers.

12. The system of claim 9, and further comprising one or more firewalls.

13. The system of claim 9, wherein the one or more databases are configured to organize at least a portion of the data according to the portion of the utility network from which the data originates.

14. The system of claim 9, wherein the one or more processors are configured to process the stored data at predetermined intervals.

15. The system of claim 9, wherein the one or more rules comprise one or more of an Inverted Meter rule, an Unauthorized Reconnection rule, and a Network Interface Card Node Insufficient Privileges rule.

16. The system of claim 9, wherein at least some of the rules are configured for one or more of a geospatial analysis of the data, an event-based analysis of the data, and a time-based analysis of the data.

17. A method for monitoring a utility meter network, the method comprising:
receiving data from at least one of a plurality of utility meters, a customer care and billing database, and a meter data management system;
storing one or more of the data in one or more databases;
processing at least a portion of the data using one or more rules to detect patterns and correlations indicative of one or more suspicious events; and
producing one or more reports if patterns and correlations indicative of one or more suspicious events are detected.

18. The method of claim 17, wherein at least one of a front-end utility application suite and a smart meter operations system receive the data from the plurality of utility meters.

19. The method of claim 18, wherein at least a portion of the data received from the one or more utility meters is queried in an ad hoc fashion by a production server to develop new rules.

20. The method of claim 17 and further comprising transmitting the one or more reports to at least one of a system administrator, a revenue assurance group, a smart meter operations group, a smart meter information security group, a smart member distribution outage analysis group, and an energy demand marketing group.
